(19) United States
(12) Patent Application Publication
(10) Pub. No.: US 2020/0364810 A1
(43) Pub. Date: Nov. 19, 2020

(54) IMPROVED ORDER MANAGEMENT SYSTEM AND METHOD

(71) Applicant: CHECKFER LIMITED, London (GB)

(72) Inventors: Richard Edward CARTER, London (GB); Rene Jean-Paul BATSFORD, London (GB)

(21) Appl. No.: 16/762,767

(22) PCT Filed: Nov. 9, 2018
(86) PCT No.: PCT/GB2018/053250

§ 371 Date: May 8, 2020

(30) Foreign Application Priority Data
Nov. 9, 2017 (GB) 1718542.2
Nov. 30, 2017 (GB) 1719958.9

(51) Int. Cl. G06Q 50/12; G06Q 10/06; G06Q 30/04; G06Q 20/32; G06Q 20/04; G06Q 10/02; G06Q 30/00; G06Q 20/08; G06Q 30/06; H04W 4/021; G06F 3/0482; H04W 4/024; H04W 4/02; G06F 3/0488; H04N 1/00

(52) U.S. Cl. CPC G06Q 50/12; H04N 1/00411; G06Q 30/04; G06Q 20/322; G06Q 20/047; G06Q 10/02; G06Q 30/0185; G06Q 20/085; G06Q 10/06315; G06Q 30/0635; H04W 4/021; G06F 3/0482; H04W 4/024; H04W 4/023; G06F 3/0488; H04N 1/00392; G06Q 10/06316

(57) ABSTRACT

Order management methods, systems and devices are disclosed. A menu associated with a general service zone (8), such as a restaurant is presented to an ordering user, typically via a screen (11) of a mobile electronic device (10), and input selections are received from the ordering user to generate an order therefrom. An order comprises at least one selected menu item from the menu, and also a unique order identifier. One of a plurality of serving locations (8a, 8b, 8c) within the general service zone (8) is chosen, and a serving location identifier that uniquely identifies the chosen serving location is determined. The order and the determined serving location identifier are associated with one another. The order and the serving location identifier are transmitted to a service instruction system (4) of the general service zone (8). A service instruction is issued, via the service instruction system (8), to service staff to fulfil the order at said chosen serving location.

### FIELD OF THE INVENTION

The present invention relates to order management, and in particular an order management system, devices for use with an order management system, and a method of managing orders. In particular, the present invention relates to an order management system that permits an ordering user to generate an order via a mobile device to be fulfilled at a serving location chosen by the ordering user.

### BACKGROUND TO THE INVENTION

Restaurants and other such establishments suffer delays in their provision of customer service. For example, delays are introduced in finding customers an available table, waiting for and then taking their orders, fulfilling those orders and receiving payment for those orders. These delays are exacerbated when the customer to staff ratio increases.

Accordingly, a more seamless and efficient way of ordering food, that isn't significantly dependent on staff is desirable.

It is against this background that the present invention has been conceived.

### SUMMARY OF THE INVENTION

According to a first aspect of the present invention there is provided an order management system comprising at least one of:
a general service zone, such as a restaurant, comprising a plurality of serving locations, such as tables;
a service instruction system for issuing serving instructions to service staff of the general service zone; and
a device associated with an ordering user.

Preferably, the device is an electronic device. Preferably, the device is a mobile device.

Preferably, the mobile device comprises at least one of a touch-sensitive screen, a sensor set and a wireless telecommunication module. Preferably, the wireless telecommunication module is arranged to download an application for execution on the mobile device, the executed application configuring the mobile device to:
present to the ordering user, via the touch-sensitive screen, a menu associated with the general service zone;
receive from the ordering user, input selections to select items on the menu to generate an order therefrom, the order comprising at least one selected menu item and a unique order identifier;
determine, using the sensor set, a serving location identifier that uniquely identifies one of the plurality of serving locations within the general service zone chosen by or on behalf of the ordering user; and/or
transmit, via the wireless telecommunication module, the order and the determined serving location identifier to the service instruction system, the order and the determined serving location identifier being associated with one another.

Preferably, the service instruction system is configured to receive a/the order and the associated serving location identifier and, in response, and may issue a serving instruction to service staff to fulfil the order at said chosen serving location.

For the avoidance of doubt, the service instruction system may comprise a printer and/or a display screen via which serving instructions and other information can be communicated to service staff to aid their fulfilment of orders.

Preferably, the order management system further comprises a plurality of identification articles. Ideally, these are each situated at a respective serving location. The executed application may configure the mobile device to determine the serving location identifier from the identification article situated at the serving location chosen by/for the ordering user.

Identification articles may take many forms. For example, an identification article may comprise a respective and unique serving location image that is displayed at its corresponding serving location. Complementary to this, the sensor set of the mobile device may comprise an image detector, such as a camera, and the mobile device can be configured by the executed application to use the image detector to scan the serving location image of the chosen serving location. Thus, the corresponding serving location identifier can be determined from the scanned serving location image. A unique serving location image can take on various forms, but for reliability of image detection and determination, the serving location image may comprise a QR code. Thus, the mobile device may be configured by the application to determine the serving location identifier of the chosen serving location by converting the corresponding QR code into the serving location identifier.

Identification articles may be implemented in other ways. For example, an identification article may comprise a beacon. The or each beacon may be arranged to wirelessly transmit a unique serving location identifier, and the mobile device is configured by the application to receive the serving location identifier transmitted by the beacon of the chosen serving location.

Advantageously, to increase the reliability of correct determination of an appropriate serving location identifier, each beacon is arranged to wireless transmit its own unique serving location identifier in a manner that substantially restricts the reception of that wireless transmission to a receiver that is situated at, or sufficiently close to, a corresponding serving location. Thus, reception is ideally restricted to a mobile device situated at the corresponding serving location.

The or each beacon may comprise a broadcasting configuration in which its unique serving location identifier is wirelessly broadcasted, and a passive configuration in which the or each beacon restricts wireless broadcasts so as to conserve power. The passive configuration may be implemented by substantially reducing the frequency and/or power at which wireless broadcasts are issued. Alternatively, the passive configuration may be implemented by eliminating wireless broadcasts.

The or each beacon may be arranged to receive an activation input, such as a vibration, and in response enter the broadcasting configuration. Naturally, upon receiving an activation input, the or each beacon may be arranged to switch from the passive configuration to the broadcasting configuration. Ideally, the or each beacon is scheduled to switch between the broadcasting configuration and the passive configuration.

Preferably, at least one of the service instruction system and the mobile device is configured and/or arranged to display a map of the general service zone. Advantageously, this can improve the efficiency with which serving staff and/or ordering users can interact with the order management system.

Moreover, it is preferred that the order management system comprises a mapping module with which the service instruction system and/or the mobile device is in communication. The mapping module may receive and/or transmit information relating to the display of the map of the general service zone.

To promote the efficiency of interaction between the order management system and serving staff and/or ordering users, the map ideally comprising a plurality of visual artefacts each uniquely representing a corresponding serving location. Moreover, the visual artefacts are ideally positioned and arranged relative to one another on the map in correspondence with the relative position and arrangement of the serving locations. For example, where serving locations are restaurant tables, the map is ideally in the form of a floorplan, with tables represented by table icons within that floorplan. Moreover, each table may have a predetermined shape and/or number. Additionally, information may be represented by the visual artefacts that is representative of properties of the serving location—for example, the number of seats available at a table. Advantageously, this can aid serving staff or ordering users to select an appropriate serving location.

Ideally, the service instruction system is configured to modify the appearance of the visual artefact associated with the serving location identifier in response to an action taken by or on the order management system. For example, the service instruction system may be configured to receive an order and the associated serving location identifier and, in response, modify the appearance of the visual artefact associated with the serving location identifier. This can be done, for instance, to reflect that a table has been taken by or allocated to an ordering user.

Moreover, the appearance of the visual artefact can be updated in response to other inputs or actions. For example, the appearance of the visual artefact can be updated in dependence on time elapsed from time of receipt of the order. This can be done, for instance, to indicate to serving staff how long an ordering user has been waiting for their order to be fulfilled. To simplify quick understanding by serving staff, the appearance of the visual artefact may be modified by colour, with a first colour indicating a first range of time elapsed, and a second colour indicating a second range of time elapsed.

As mentioned, the order management system may comprise a mapping module. The mapping module may be configured to determine the relative position and arrangement of the serving locations within the general service zone. In response, the mapping module may be configured to transmit that determination to the service instruction system and/or the mobile device.

To facilitate this, the mapping module determines the relative position and arrangement of the serving locations by communicating with identification articles, each situated at a respective serving location. The identification articles may be arranged to issue wireless localisation signals, the reception of which enables the determination of the position of each identification article relative to at least one other.

Ideally, the mapping module comprises a graphical user interface arranged to receive a user input to designate the relative position of serving locations within the general service zone.

Preferably, the service instruction system comprises a screen on which the serving instruction is displayed, and/or a printer via which the serving instruction is printed.

Preferably, the each menu item has an associated cost, and the executed application configures the mobile device to calculate a total cost of the order from the aggregated cost of each menu item selected by the user.

Preferably, the executed application configures the mobile device to present, via the touch-sensitive screen, the total cost of the order to the user.

Preferably, the executed application configures the mobile device to issue, via the wireless telecommunication module, a payment request to a remote payment system, the payment request including the total calculated cost of the order. Ideally, the mobile device is further configured to receive a payment receipt from the payment system to certify successful payment for the order. Preferably, the service instruction system is configured to receive a payment confirmation from the remote payment system, the payment confirmation certifying successful payment for the order.

Preferably, the service instruction system is configured to receive the payment confirmation and, in response, include within the serving instruction information confirming successful payment for the order.

Preferably, the executed application configures the mobile device to determine the location of the mobile device relative to the general service zone, and execute a proximity routine on determining that the mobile device is within a predetermined proximity to the general service zone. Determination of the location of the mobile device may be by using the sensor set and/or the wireless telecommunication module.

To this end, the general service zone may comprise a location beacon arranged to interface with the mobile device proximal to the general service zone, the proximity routine being executed in response to the interface between the location beacon and the mobile device. For example, the location beacon may transmit a signal that is received by the wireless telecommunication module of mobile device, receipt of which causes execution of the proximity routine.

The proximity routine may comprise displaying, via the touch-sensitive screen, a proximity prompt to indicate to a user the proximity of the mobile device to the general service zone. The proximity prompt may be user-interactable so that the user can confirm intended proximity to the general service zone. This may control the execution of the rest of the proximity routine, or other functions enabled by the application. For example, only if the ordering user confirms that they have entered a restaurant, and desire to use the application for ordering is it necessary for the application to carry out the rest of the proximity routine, and/or any other steps enabled by the application. Such steps could include presenting a menu associated with the general service zone, receiving input selections to select items on the menu, determining a serving location identifier, and/or transmitting an order to the service instruction system.

Moreover, the proximity routine ideally comprises downloading, via the wireless telecommunication module, the menu associated with the proximal general service zone (i.e. that is determined to be within a predetermined proximity of the mobile device).

Preferably, the ordering management system is configured to determine reservation information associated with at least one serving location within the general service zone. Reservation information can be, for example, whether a serving location is available for use or occupation by a prospective ordering user.

Additionally, the executed application may configure the mobile device to receive and display, via the touch-sensitive screen, the reservation information to a user thereby identifying to a user the availability of the at least one serving location.

Preferably, the executed application configures the mobile device to display, via the touch-sensitive screen, guidance instructions to guide the user to the at least one serving location.

Preferably, the guidance instructions comprise a map of the general service zone, the map comprising a plurality of visual artefacts each uniquely representing a corresponding serving location. The map may be provided by the mapping module, as previously discussed. Thus, the visual artefacts may be positioned and arranged relative to one another on the map in correspondence with the relative position and arrangement of the serving locations.

The executed application may configure the mobile device to, in response to determining the serving location identifier:
display, via the touch-sensitive screen, an identification of the serving location associated with the determined serving location identifier; and
receive a check-in interaction from the user to confirm acceptance by the user of the identified serving location and in response transmit, via the wireless telecommunication module, the determined serving location identifier to the service instruction system.

Again, this can be useful from the perspective of minimising unnecessary transfer of data between components of the system, and also ensuring that the data that is transmitted is correct and appropriate for the purpose of maximising the efficiency of the order management system.

Preferably, the sensor set of the mobile device comprises a camera (or another such image sensor). Advantageously, the executed application can configure the mobile device to utilise the camera to improve the manner in which ordering users are able to interact with the order management system.

In particular, the executed application ideally configures the mobile device to present, via the screen, an augmented reality view of the general service zone. Moreover, virtual (augmented reality) representations (or simply “virtual representations”) of menu items, and/or guidance instructions (such as the location of one or more available serving locations) may be presented simultaneously with an image of at least a part of the general service zone as captured by the camera of the mobile device.

Preferably, the executed application is arranged to determine, via the sensor set, the position and orientation of the mobile device relative to that of the general service zone and in response modify the size, shape and/or orientation of the virtual (augmented reality) representations of the menu items and/or guidance instructions to give the appearance of the virtual (augmented reality) representations being at fixed locations within general service zone.

Naturally, to this end, the mobile device may comprise position and orientation sensors—for example in the form of accelerometers, gyroscopes, compasses or the like.

Preferably, the executed application configures the camera of the mobile device to capture a live image feed that is continuously displayed, in use, on the screen of the mobile device, the modification of the virtual (augmented reality) representations being continually updated in response to movement of the mobile device relative to the general service zone.

Preferably, the executed application may configure the mobile device to modify the size, shape and/or orientation of the virtual (augmented reality) representations of the menu items to give the appearance of those virtual (augmented reality) representations being presented in place at the chosen serving location. For example, a plate of food that corresponds to a menu item can be shown in place on the surface of a table corresponding the chosen serving location.

Preferably, the order management system further comprises a virtual representation generation module for generating virtual representations of menu items by scanning physical items, such as a meal prepared by a restaurant.

Preferably, the virtual representation generation module comprises a 3D scanning system for generating three-dimensional models of scanned physical item. Ideally, the models are colour three-dimensional models. Preferably, the virtual representations (e.g. of menu items) comprise said models.

Preferably, the order management system further comprises a menu populating module for populating the menu of the application. Preferably, the menu populating model is arranged to generate a plurality of menu items each having associated with it a respective virtual representation.

Preferably, the order management system further comprises a service staff tracking system for tracking the position of service staff members relative to the plurality of serving locations.

Preferably, the service staff tracking system is configured to determine a fulfilment visit by at least one service staff member to the serving location chosen by/for the ordering user, the fulfilment visit fulfilling at least part of the order.

Preferably, the service staff tracking system is configured to transmit an identification of said at least one service staff member to the mobile device associated with the ordering user.

In response, the mobile device, may be configured to:
present to the ordering user, via the touch-sensitive screen, an identification representation of the at least one service staff member;
receive from the ordering user, via the touch-sensitive screen, a tip payment input that specifies a tip value and an identification of the service staff member chosen by the ordering user as a recipient of that tip value; and/or
transmit, via the wireless telecommunication module, a tip payment request to a remote tip payment system, the tip payment request including the tip value and the identification of the service staff member specified by the ordering user.

Preferably, the identification representation comprises at least one of: a name of the service staff member and an image, such as a photograph, of the service staff member.

Preferably, the service staff tracking system comprises a plurality of portable service staff tracking devices, each being carried by a respective service staff member.

Preferably, each portable service staff tracking device comprises an identity badge worn by a respective service staff member, the identity badge supporting indicia visible to ordering users and conveying information about the identity of the service staff member.

Preferably, each staff tracking device is arranged to transmit a localisation signal for use in determining the position of a respective tracking device relative to the plurality of serving locations.

Preferably, the order management system further comprises a plurality of beacons each situated at a respective serving location, a selection of beacons and staff tracking devices wirelessly communicating with one another to determine the relative position between staff tracking devices and beacons.

Preferably, each staff tracking device wirelessly transmits a unique staff identifier.

Further aspects of the invention may reside in a service instruction system for use with the order management system of the first aspect.

Further aspects of the invention may reside in a mobile device for use with the order management system of the first aspect, the mobile device for example comprising a touch-sensitive screen, a sensor set and a wireless telecommunication module, the wireless telecommunication module being arranged to download an application for execution on the mobile device.

Further aspects of the invention may reside in an application for downloading to such a mobile device.

Further aspects of the invention may reside in an identification article for use with the order management system of the first aspect, the identification article being adapted for provision at a serving location within the general service zone. For example, the identification article may be adapted for provision at a serving location by providing the identification article with adhesive means to stick it at the serving location. For example, this may be implemented by fixing a beacon underneath a table using adhesive.

Further aspects of the invention may be provided in methods of managing orders and/or of operating order management system according to the first aspect.

An aspect of the invention, for example, may reside in an order management method comprising at least one of the steps of:
presenting to an ordering user, via a screen of an electronic device, a menu associated with a general service zone, such as a restaurant;
receiving input selections from the ordering user to select items on the menu to generate an order therefrom, the order comprising at least one selected menu item and a unique order identifier;
determining one of a plurality of serving locations within the general service zone chosen by or for the ordering user;
determining a serving location identifier that uniquely identifies the chosen serving location;
associating the order and the determined serving location identifier with one another;
transmitting the order and the determined serving location identifier to a service instruction system of the general service zone; and
issuing a service instruction, via the service instruction system to service staff to fulfil the order at said chosen serving location.

It will be understood that features and advantages of different aspects of the present invention may be combined or substituted with one another where context allows.

Furthermore, such features may themselves constitute further aspects of the present invention. For example, the features of the ordering management system, such as the mobile device and service instruction system may themselves constitute further aspects of the present invention.

Additionally, aspects relating to order management methods may further include steps carried out by components of the ordering management system. Conversely, aspects relating to ordering management systems, or components thereof, may implement steps associated with ordering management methods.

### SPECIFIC DESCRIPTION OF THE PREFERRED EMBODIMENTS

In order for the invention to be more readily understood, embodiments of the invention will now be described, by way of example only, with reference to the accompanying drawings.

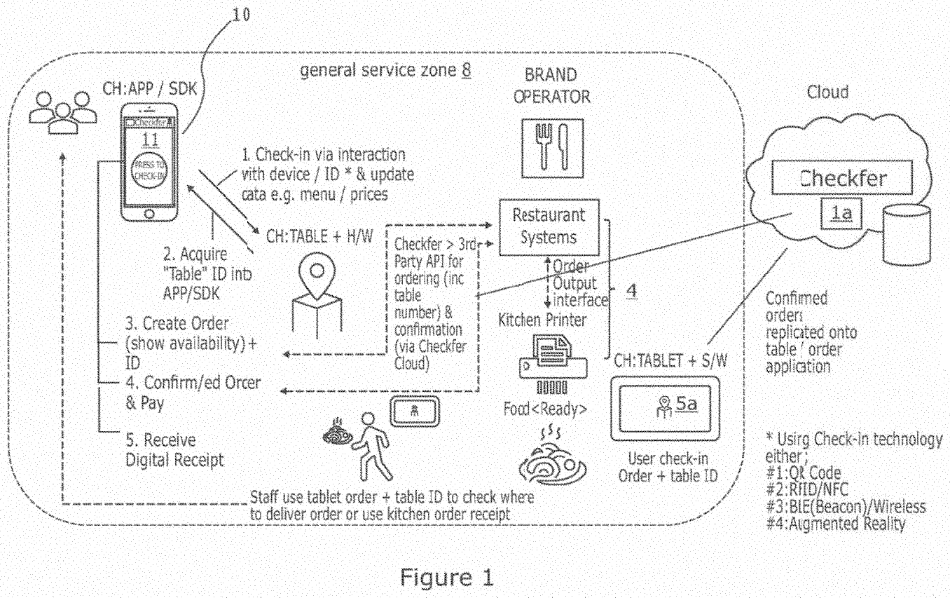

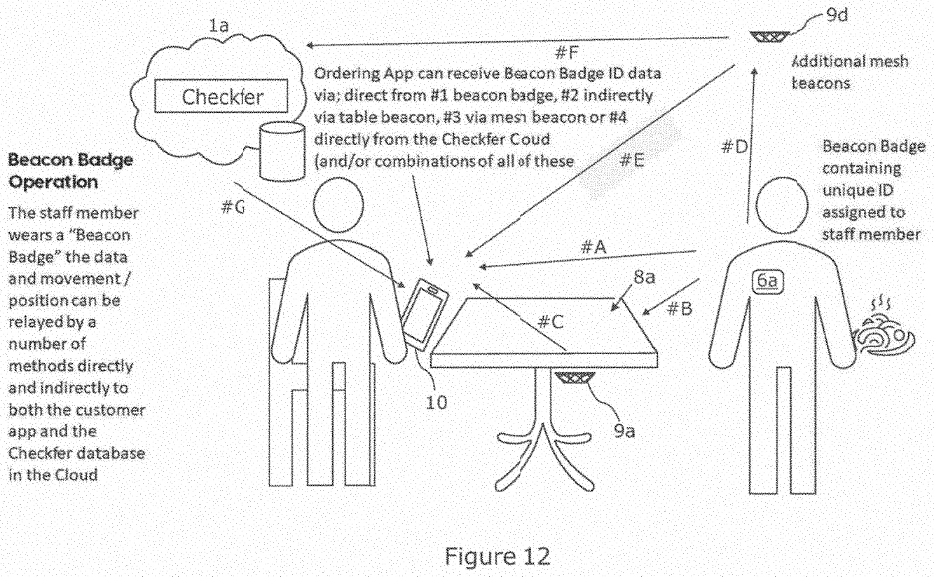

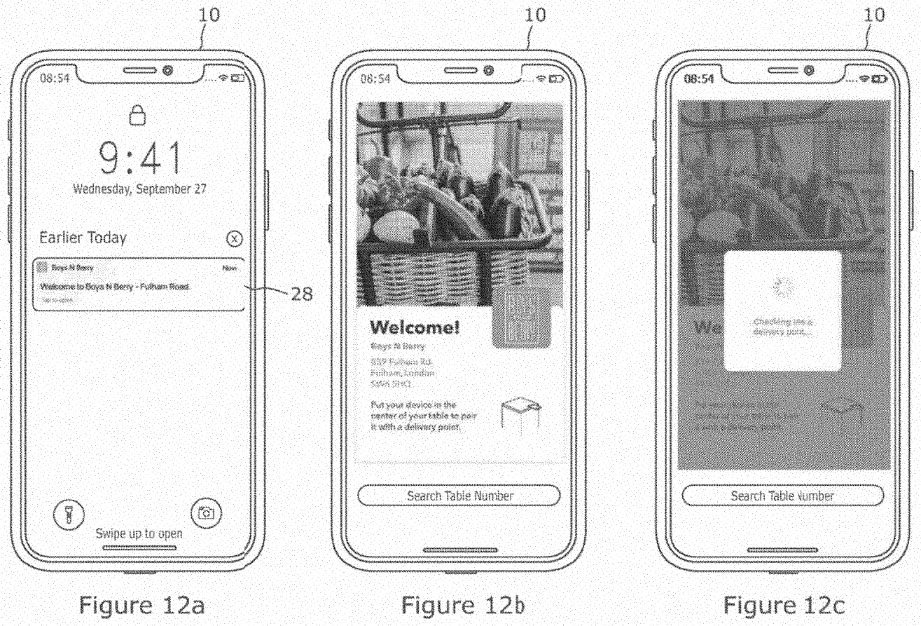

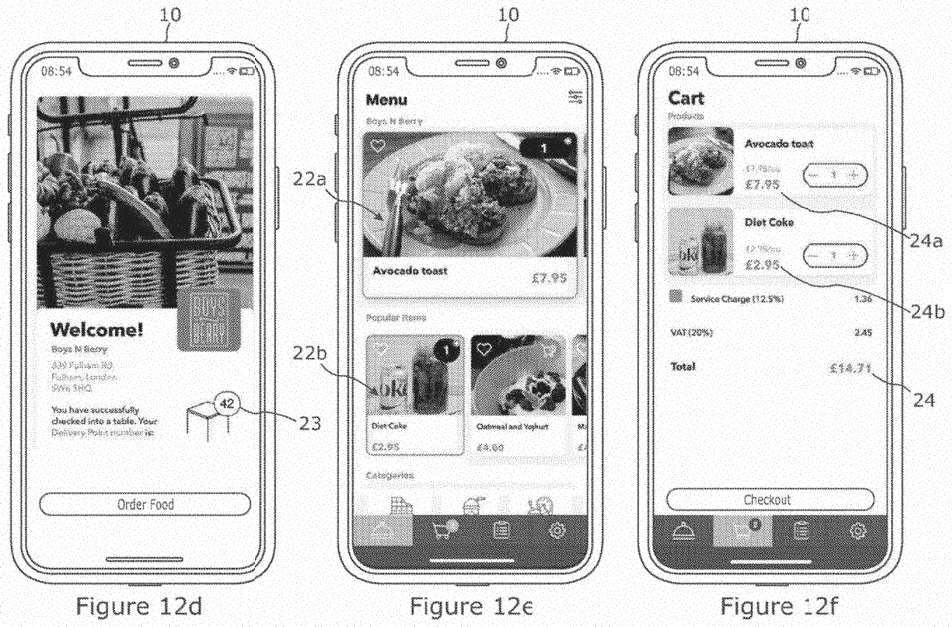

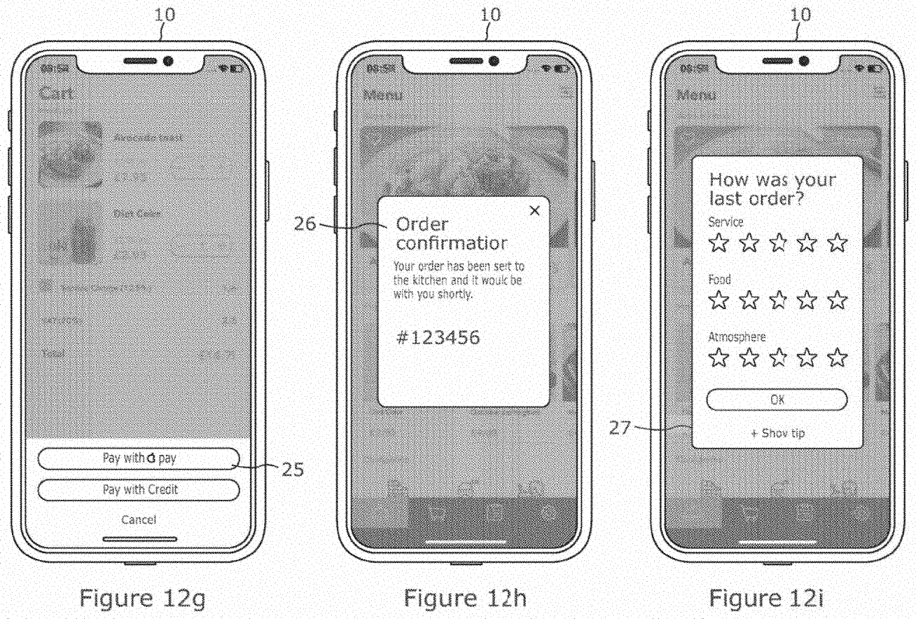

In particular, a generalised embodiment of the invention will first be described with reference to FIGS. 12a-12i, 13 and 14, and then followed by more specific examples and embodiments with reference to FIGS. 1 to 12.

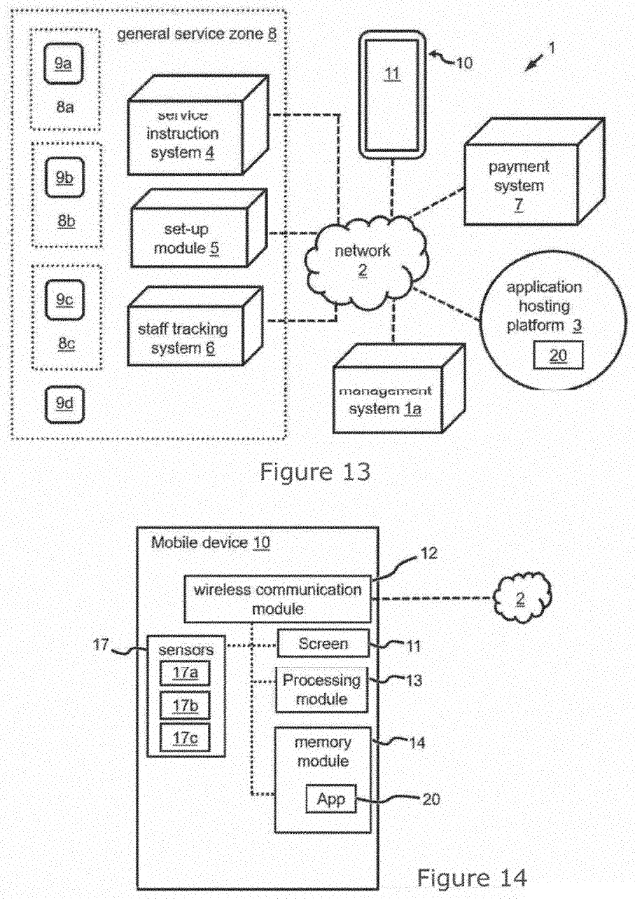

FIG. 13 is a schematic overview of an order management system 1 of a generalised embodiment of the present invention. The system 1 comprises a management system 1a, an application hosting platform 3 that hosts an application or app 20, a service instruction system 4, a set-up module 5, a staff tracking system 6, a payment system 7, a plurality of beacons 9a, 9b, 9c, 9d, and a mobile user input device 10. Each of these components are communicatively interlinked to one another via a communications network 2.

It should be noted that, in this generalised embodiment of the present invention, the functions and features of the beacons 9a, 9b, 9c, 9d, the service instruction system 4, the set-up module 5, and the staff tracking system 6 are provided, at least in part, on the premises of a general service zone 8 such as a restaurant. Thus, for speed and efficiency, communication between these components can take place via a communications network local to the general service zone 8. Nonetheless, their separation in FIG. 13 is shown schematically to illustrate their functional role and relationship.

Moreover, it will be understood that the systems referred to herein, may not necessarily be in the form of a single physical machine. The term “server” may encompass, for example, a distributed or “cloud” computing service, engine, service or platform. To this end, for example, part of the features and functions of the service instruction system 4 and set-up module 5 may be implemented on the management system 1a which may store, process and transmit information between the other components of the system 1 as a whole.

The mobile device 10 is in the form of a smartphone having a touch-sensitive display screen 11 on which can be displayed user interface (UI) elements. These can communicate a state of the mobile device 10 or system 1 to a user, or provide a means by which a user can input information to the mobile device 10 (e.g. for communicating to other components of the ordering management system 1) via interacting with those UI elements—for example via a touch-interaction with the touch-sensitive screen 11. A range of non-limiting exemplary UI elements are shown in FIGS. 12a to 12i each of which show a mobile device 10 configured by the app 20 to display such UI elements.

Referring back to FIG. 13, it will be understood that, in practice, the order management system 1 will have a plurality components of the same type. For example, there could be many mobile devices, possibly numbering in the thousands or millions, or more. However, for clarity, a single system component type (e.g. mobile device 10) is depicted in FIG. 13, and representative of each of the potentially multiple components of that type.

FIG. 14 is a schematic block diagram of the mobile device 10 of FIG. 13. The mobile device 10 further comprises a wireless communication module 12 for interfacing with the network 2, a processing module 13, and a memory module 14. The mobile device 10 also comprises a sensor set 17 as typically found on most smartphones, the operation and use of which is well-known to those skilled in the art. By way of non-limiting example, the sensor set 17 comprises an IMU (inertial measurement unit) 17a, a camera 17b, and a reference-based positioning module 17c in the form of a GPS module. The mobile device is configured to determine from the IMU 17a the position, orientation and movement (e.g. acceleration) of the mobile device 10 in 3D space. The mobile device is configured to operate the camera 17b to capture an image or image sequence or stream (e.g. video). The GPS module 17c allows the mobile device 10 to infer an absolute position of the mobile device 10 on Earth, and moreover, can provide a stable and highly reliable timing reference in a manner known in the art.

The memory module 14 is structured so as to transiently or persistently store data, and is where an operating system, file system and applications of the mobile device 10 are stored. Applications are retrieved from the memory and passed to the processing module 13 for execution at run-time.

The mobile device 10 further comprises other components that are typically common in smart-phone and tablet devices, but are not necessarily shown in the drawings. By way of non-limiting example, these other components include other sensors such as an NFC (near-field communication) component, a light intensity sensor, a proximity sensor, a compass, a battery, a timer, audio transducers, tactile transducers (e.g. vibration transducer), and a clock. The components of the mobile device 10 are functionally and communicatively linked to one another as schematically indicated by the dotted lines in FIG. 14.

The mobile device 10 may also comprise additional communication modules (e.g. Wi-Fi, BLE/Bluetooth, cellular etc.), to allow communication with other components or sub-components of the system 1. In particular, the NFC component may be used for communication.

It should also be noted that one or more communication modules may also act as sensors—in particular location sensors. This can be achieved via detecting the presence and proximity of communication signals (e.g. via time-of-flight, or signal strength).

Referring back to FIG. 13, by way of overview, the system 1 is configured to make an application 20 (or “app”) available for download on to the mobile device 10. The downloading and execution of the app 10 provides functionality otherwise not available to that mobile device 10.

In particular, the app 20 provides some of the functionality of the system and method of managing orders, as will be described in greater detail below. The provision of the app 20 is ideally via the network 2 from a third-party application hosting platform 3, for example, an Android or iOS “app store” as is well-known in the art. In some examples, a hyperlink or similar may be provided via the UI elements of the mobile device 10, which—when selected by a user—guides the mobile device 10 to the location of the appropriate application hosted by the app hosting platform 3. This can then be downloaded via the wireless communication module 12 on to the memory module 14 of the mobile device 10.

The app 20, when run or managed by the mobile device 10, in conjunction with the app hosting platform 3, is configured to automatically detect when the application requires updating, and either automatically updates itself (optionally first prompting a user to affirm that an update should take place).

The app 20 controls the touch-sensitive display screen 11 to present user interface (UI) elements that can be used to compile orders. In particular, a menu associated with the general service zone 8 is presented, and can receive input selections to select items on the menu to specify an order to be fulfilled by service staff of the general service zone 8.

Furthermore, the app 20 is configured to establish a communication link via the network 2 between the mobile device 10 and the other components of the system 1 to result in minimised delay in the delivery of a service provided to the user of the mobile device 10 at the general service zone 8.

In the generalised embodiment described herein, the general service zone 8 is in the form of a restaurant having a plurality of serving locations 8a, 8b, 8c in the form of tables. Accordingly, delay can be minimised by reducing the length of periods normally associated with allocating customers of the restaurant to an available table, waiting for and then taking their orders, fulfilling those orders and receiving payment for those orders.

To this end, the mobile device 10 is controlled by the app 20 to enable a user of the mobile device 10 to be allocated to an available table 8a, 8b, 8c, formulate a valid order and transmit it to service instruction system 4, and arrange for a payment transaction associated with that order to be conducted with the payment system 7.

To facilitate this, a beacon 9a, 9b, 9c is situated at a respective table/serving location 8a, 8b, 8c. Each of these beacons act as an identification article with which a mobile device 10—as controlled by the app 20—can interact to determine a serving location identifier associated with a respective serving location 8a, 8b, 8c. Thus, the executed application 20 can configure the mobile device 10 to receive selections from the menu to generate an order therefrom and, using one of the beacons 9a, 9b, 9c, a serving location identifier can be associated with that order, thereby allowing service staff to fulfil that order at the right location.

More specifically, and referring briefly to FIG. 12e, the mobile device 10 is configured by the app 20 to present to the ordering user, via the touch-sensitive screen 11, a menu 21 associated with the general service zone 8. Thereafter, the mobile device 10 is configured by the app 20 to receive from the ordering user, input selections (e.g. via touch interactions with the touch-sensitive screen 11) to select items on the menu to generate an order therefrom. The order generally comprises one or more selected menu item 22a, 22b and a unique order identifier. Naturally, the app 20 may configure the mobile device 10 to determine such a unique order identifier.

The mobile device 10 is also configured by the app 20 to determine, using the sensor set, a serving location identifier that uniquely identifies one of the plurality of serving locations 8a, 8b, 8c within the general service zone 8. To this end, each respective beacon 9a, 9b, 9c is arranged to wireless transmit a unique serving location identifier, and the mobile device 10 is configured by the app 20 to receive, via the wireless communication module 12 (or one of the sensors, such as the NFC component) the serving location identifier transmitted by the beacon 8a, 8b, 8c of the respective serving location 9a, 9b, 9c.

Thus, a vacant and available table can be chosen by the ordering user, and occupied by that user both physically within the general service zone 8 and digitally via registration between the mobile device 10 and respective beacon. Alternatively, the app 20 can configure the mobile device 10 to determine an available table, and suggest this to the user, or even choose the table on behalf of the user. Referring to FIG. 12d, a UI element 23 relating to the chosen serving location (e.g. table number) can be displayed by the UI of the app 20, and this also signals to a user that registration with a particular serving location 9a has been successful.

Referring back to FIG. 13, the mobile device 10 is configured by the app 20 to transmit, via the wireless telecommunication module 12, the order and the determined serving location identifier to the service instruction system 4. The service instruction system 4 is configured to receive the order and the associated serving location identifier and, in response, issue a serving instruction to service staff to fulfil the order at said serving location chosen by the ordering user.

It should be noted that the order (which includes at least one selected menu item, and a unique ordering identifier) may be transmitted to the service instruction system 4 independently to the serving location identifier. The serving location identifier can be transmitted before or after the transmission of the order, so long as information is included that can be used to associated or otherwise pair the serving location identifier with the order. For example, the serving location identifier may be transmitted later, together with the unique ordering identifier, and matched by the service instruction system 4 with the relevant earlier-submitted order.

Referring to FIG. 12f, the mobile device 10 is also configured by the app 20 to calculate a total cost of the order 24 from the aggregated cost of each menu item 24a, 24b selected by the user—and these values can be displayed by the UI of the app 20.

Referring to FIG. 12g, the mobile device 10 is also configured by the app 20 to receive, via an interactable UI element 25, an interaction from the user to initiate a payment process for the order. Referring back to FIG. 13, this includes issuing, via the wireless telecommunication module 12, a payment request (including the total calculated cost of the order) to the payment system 7.

The payment system 7 processes a payment transaction, and issues a payment receipt that certifies successful payment for the order. This can be sent to both the mobile device 10 and the service instruction system 4, the latter thus settling payment for service. Upon receipt of payment, an order confirmation 26 may be sent to the mobile device 10, and displayed via the app-controlled UI—as shown in FIG. 12h.

Thus, the otherwise linear process of finding a vacant table, seating, receiving an order, fulfilling an order, and payment can be modularised in a way that minimised delay.

Furthermore, the fulfilment and payment of an order can be enhanced via the staff tracking system 6. This allows an ordering user to receive information about the location or expected delivery time of an order, and also provide feedback about their service experience, including feedback about a staff member fulfilling an order—for example by leaving them a tip for good service. FIG. 12i shows an exemplary UI element 27 of the app 20 that receives an interaction to provide a star rating for various service elements, and an option to display/provide a tip.

Referring back to FIG. 13, it will be appreciated that embodiments may be applicable to many different general service zones 8, each with its own menu, table layout, service instruction system etc. This can present a technical problem, in that this demands that the mobile device 10 is configured and operates in an appropriate and unique way for each general service zone 8. For example, storing configuration and operating instructions for every different general service zone 8 can quickly exceed the space available on the memory module 14 of a mobile device 10. Additionally, the most appropriate configuration and mode of operation has to be implemented at the right time.

To address this, the app 20 can be adapted in response to the physical proximity of the mobile device 10 to a specific general service zone 8.

In general, the app 20 configures the mobile device 10 to determine the location of the mobile device 10 relative to the predetermined location of a general service zone. In response, the most appropriate configuration and mode of operation can be implemented.

Moreover, a proximity routine can be executed on determining that the mobile device is within a predetermined proximity to a given general service zone.

This can be implemented in a number of ways. For example, the location of the mobile device 10, as detected via the sensor set (e.g. the GPS module 17c), can be compared with a known location of a general service zone 8, and the proximity routine executed in response. However, this necessitates regular polling of the location of the mobile device 10 which can be wasteful of processing and battery power. Furthermore, this arrangement is prone to false positives and negatives. For example, the proximity routine may be erroneously triggered if a user passes by, but does not enter, a general service zone 8. Alternatively, if the GPS module is not enabled, or cannot receive localisation signals, the proximity routine may fail to be triggered.

To address this, each general service zone 8 comprises a location beacon 9d, ideally situated close to an entrance to the general service zone 8, and configured to transmit a location signal that is unique to the respective general service zone 8. Moreover, transmission is restricted in direction or power so that the location signal is receivable only within the respective general service zone 8.

The app 20 can configure the mobile device 10 to detect the presence of such a location signal and, in response, execute the relevant proximity routine. Thus, a wireless communication module 12 of the mobile device 10 may act as location sensor.

The proximity route generally includes the app 20 configuring the mobile device to issue, via the UI, a proximity prompt to indicate to a user the determined proximity of the mobile device 10 to the general service zone 8.

Referring to FIG. 12a, such a prompt 28 may be displayed on a lock-screen of the mobile device 10, and is user-selectable to provide a user input to confirm that the user has entered the general service zone 8 and wishes to place an order.

Following on from this, the proximity routine ideally comprises downloading the menu associated with the proximal general service zone. In this way, false positives and negatives can be eliminated, and also processing power and memory usage of the mobile device 10 can be minimised.

Additionally, if the menu associated with the proximal general service zone has already been downloaded (for example, as a result of a prior visit), the proximity routine may simply cause the app 20 display a greeting screen such as that shown in FIG. 12b.

Such a greeting screen includes guidance to the user about how to operate the mobile device 20 to progress with an order—for example, by placing the mobile device 10 on an available serving location (having a beacon) to “check-in” to that serving location (FIG. 12c).

Referring back to FIG. 13, as mentioned, each general service zone 8 is likely to have its own menu, pricing, table layout etc. Accordingly, a set-up module 5 is provided which provides the function of allowing an operator to generate, update and customise, for each general service zone 8, information utilised by components of the ordering management system.

In particular, the set-up module 5 provides a mapping module to generate, alter and display a map of the general service zone. Furthermore, the set-up module 5 provides a menu populating module for populating images, models (e.g. 3D models), prices, descriptions associated with a menu. Generally, information created or updated via the set-up module 5 is also transmitted stored within the management system 1a.

The set-up module 5 is typically embodied, at least in part, by an operator tablet device 5a and also an augmented content capture setup apparatus 5b as will be described in greater detail below in relation to the more specific examples and embodiments of the present invention.

Features described above in relation to the generic embodiment are referred to by the same name in the more specific examples and embodiments of the present invention to aid comparison.

In certain specific embodiments described below, the ordering system or components thereof may be referred to by the name “Checkfer”. Also reference to “Checkfer cloud” is a reference to a service akin to that of the management system 1a of FIG. 13.

In general, a technological solution is provided that allows an ordering user (e.g. customer) the ability to “check-in” to a designated area, typically by electronically signalling a registration with that area. That designated area can therefore generally relate to serving location 8a, 8b, 8c where an order is to be fulfilled.

This can be achieved through the use of coupling a mobile device 10, an application 20/software on device (APP/SDK) and “check-in” technology—for example, Bluetooth (BLE) and/or similar wireless device 9a, 9b, 9c—situated on/in or under a designated area—specifically—table/seating/counter/wall/floor/ceiling/flat surface and/or incorporated into signage.

In an embodiment of the invention, the ordering system comprises:
Beacon Hardware—a programmable beacon, consisting of a circuit board and chipset, antennae and battery housed within a durable casing combined with an adhesive to affix the casing to any surface, typically a wall or underside of a table.
Beacon configuration—a convention comprising and utilizing the Beacon/BLE standards UUID (unique universal Identifier, typically 32 alpha-numeric character string set), Major Key (5 digit integer), Minor Key (5 digit integer)—programmed to incorporate brand operator ID, location ID and Table ID, as well as Area ID; area's with-in or just outside an establishment's location—e.g. ground floor, lobby, street, etc.
Checkfer Ordering SDK/software/app—software that allows the consumption of both the Location Beacon ID and Table Beacon ID so that it can be acknowledged and sent through as part of an order—this software sits within a 3^{rd} party ordering application or Checkfer's own mobile ordering application.
Checkfer Interface/Gateway—a software interface that allows a confirmed order to pass from the Ordering SDK through to the brand operators designated restaurant/kitchen system/s. It also allows data to be passed back through from the designated restaurant/kitchen system/s to update things such as menu/availability and price etc. The interface is adapted to each kitchen/restaurant system.
Checkfer Configuration SDK/software/app—software that allows the beacons to be programmed with specific UUID, Major Key, Minor Key to incorporate Location ID, Table ID, Area ID for use by the Checkfer Ordering SDK and the Checkfer Table Management SDK.
Checkfer Table Management SDK/software/app—software that allows data pertaining to location, area and table layouts to be configured and visualised so that brand operators staff can see where customers/orders are located. For example, this allows staff to know where to take orders that are ready to the correct tables.

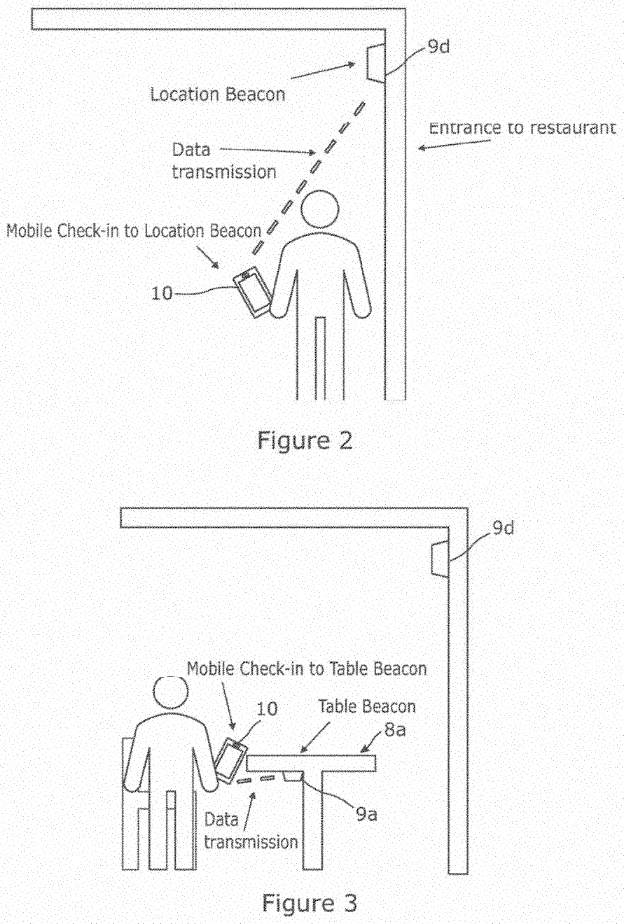

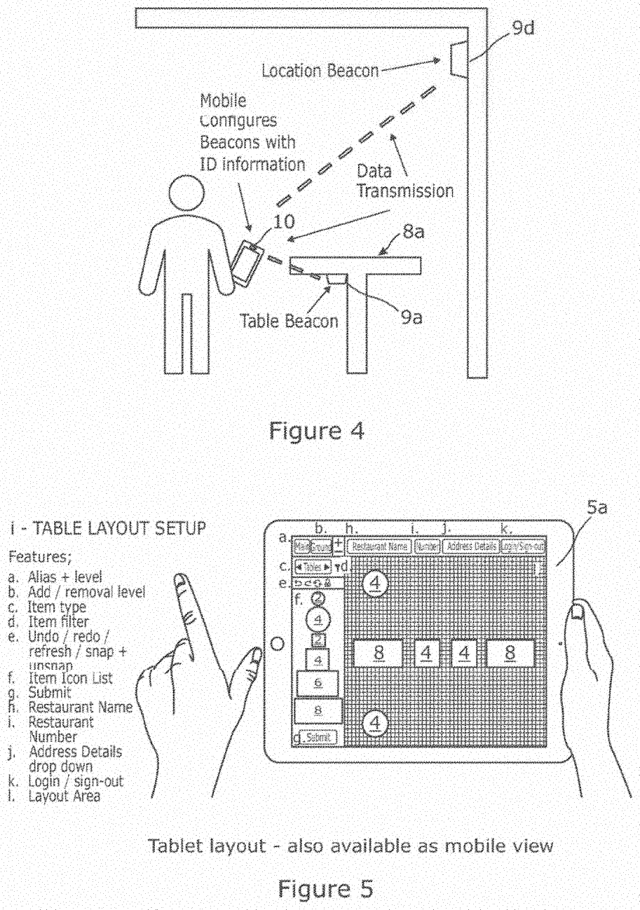

In such an embodiment, or variations thereof:
FIG. 1 is a process flow view showing how the various components of the system 1 are integrated and interfaced;
FIG. 2 is a side plan view of a deployed location beacon 9d at an entrance to a restaurant (embodying a general service zone 8) showing a customer check-in with their mobile device 10;
FIG. 3 is a side plan view of a deployed table beacon 9a beneath a table (embodying a service location 8a) at a restaurant 8 showing a customer check-in with their mobile device 10; and
FIG. 4 shows a brand operator configuring the beacons 9a, 9b, 9c using a mobile tablet device 5a which is part of the set-up module 5 referred to above.

A beacon (BLE) is provided that is situated on/in or under a designated area—specifically—table/seating/counter/wall/floor/ceiling/flat surface and/or incorporated into signage.

The beacon (BLE) contains a configurable identity (“ID”) based on the Bluetooth Standards Convention; UUID, Major Key, Minor Key.

The combination of these allows a mobile ordering program (provided by a 3rd party software solutions company and/or the brand operator and/or Checkfer Limited) embedded with the Checkfer SDK (software) to;
Firstly “location check-in” with-in or near the establishment by attaining the data programmed within the “location beacon”, the “location ID information” this allows the mobile application to both guide the “user/customer” to the next part of the process as well as performing other functions such as menu/price updates/or skip to order and pay to “take-out” as opposed to dine-in.
Secondly the process allows the “user/customer” of the mobile device on which the ordering software is installed to “table check-in” via the “table check-in beacon” to a designated area with-in the establishment, this could be a seated/table (for table ordering) this allows the ordering process to consume in this instance the “table beacon ID” which can then be used in the ordering and payment process as part of a package of data that can be transmitted via the mobile wireless to an interface for the e.g. restaurants kitchen system.
Thirdly both the “location & table check-in beacon and data” can be used for other systems such as a table management software solution that can cross reference the customer check-in, the table that they are sitting at and the orders they have placed and paid for as part of the “check-in and ordering and payment process”.

The invention possesses numerous benefits and advantages over other forms of digital and non-digital check-in solutions. In particular the invention allows the customer to bypass traditional restaurant processes e.g. arrive, wait to be seated, wait for menu to be handed, wait to order and wait to pay. This is replaced by the fact that the customer can just turn up, take a seat and order and pay and leave once they are finished. All the establishment need to do is take their food to the table.

This provides efficiency savings for both the customer and the restaurant in terms of time/cost as the location of the customer is attained via the beacon ID's and broadcast as part of the ordering and payment without the brand operator having to get the customer seated and take their ordering—this is all done via the customer, via their mobile 10 via the application 20.

The solution is very practical and seamless as the beacons 9a, 9b, 9c can be easily deployed by the brand operator staff within the establishment 8 as the casing in which the beacons are housed can be attached by use of adhesive pads to the underside of tables 8a, 8b, 8c, on walls etc.,—anywhere proximal to a serving location. Each beacon is powered by an internal battery which typically has a life of around 2 years, and the batteries can be easily replaced.

The solution also includes a configuration process through use of scanning the deployed beacons with a mobile device 5a on which the “Checkfer Configuration” software is deployed which allows each beacon to be programmed by attributing a location number ID and Table number ID as outlined above. This is mapped to a table listing and/or layout, which shows the location of each table either on a graphical layout and/or list, this can be deployed on any mobile or computing device to allow the brand operator and its employees the location and status of orders and tables.

An ability is thus provided to “check-in” to a table, or another serving location, using a mobile device 10 and using a fixed or removable beacon that is given a unique designation e.g. table number—for the purposes of a check-in and food ordering and payment process.

Referring to FIG. 2, the ability to “check-in” to a location/area using a mobile device 10 and a fixed or removable beacon is depicted. The location beacon 9d is given a unique designation e.g. location number—for the purposes of a check-in and food ordering and payment process, and allows the unambiguous determination that a mobile device 10 has entered within a specific service zone/restaurant 8.

Referring to FIG. 4, an ability to “configure” location and table beacons is depicted—for the purposes of a check-in and food ordering and payment process.

Referring to FIG. 3, the deployment of a table beacon 9a beneath (or on a surface of) a table or chair/bench or other form of furniture—for the purposes of a check-in and food ordering and payment process—is shown.

More generally, an order management system 1 may be provided which has a general service zone 8 within which a plurality of serving locations 8a, 8b, 8c are provided. In many embodiments described herein, the general service zone 8 is a restaurant and the serving locations are tables, but other variations are possible. For example, the general service zone may be a car park, and the serving locations may be parking bays.

Nonetheless, in general, the order management system 1 comprises a service instruction system 4 for issuing serving instructions to service staff of the general service zone 8.

Customers/ordering users utilise a mobile device 10 that is associated with them to place orders. Advantageously, the mobile device 10 is in the form of a smart-phone which can download and execute an application customised by the owner of the general service zone. Accordingly, menu items can be provided to an ordering user that are specific to items that can be procured by the general service zone. Moreover, the application configures the mobile device 10 to present to the ordering user, via a screen 11 of the mobile device 10, a menu associated with the general service zone 8, and then receive from the ordering user, input selections to select items on the menu. This is used to generate an order, the order comprising at least one selected menu item and a unique order identifier.

A sensor set 17 of the mobile device 10 (and/or a wireless communication module 12) can be configured by the application 20 to determine a serving location identifier (for example, transmitted by a beacon 9a that is on/under a table 8a chosen by or for a customer).

A wireless telecommunication module 12 of the mobile device 10 can be used to transmit the order and the serving location identifier to the service instruction system 4 which can then receive the order and the associated serving location identifier and, in response, issue a serving instruction to service staff to fulfil the order at said serving location chosen by the ordering user.

It should be noted that the serving location identifier need not necessarily be provided via a beacon. In general, an identification article is provided at a respective serving location, and the mobile device is configured by the application to determine what the serving location identifier is from the identification article.

For example, the identification article may be in the form a QR code which can be scanned via a camera of the mobile device in order to determine the serving location identifier. However, the identification article may bear other serving location images which can be recognised or interpreted by the mobile device as belonging to a particular serving location (and so generate or look up from that a serving location identifier). For example, the application may be loaded with predetermined images of tables of a restaurant, with each table having a unique appearance which can be scanned and recognised by the mobile device 10.

The recognition of a serving location 8a (and its associated identifier) may be supplemented via other means. For example, the mobile device may utilise its sensor set to determine it location relative to/within the general service zone 8. For example, the mobile device may use wireless localisation means (e.g. utilising time-of-flight and/or triangulation of radio signals issued by transmitters) to establish its location within the general service zone 8. This, together with information concerning the location of each of the serving locations 8a, 8b, 8c within that general service zone 8 can assist the mobile device 10 in determining its proximity to a serving location chosen for/by a user, and so the mobile device 10 can perform a look-up of the serving location identifier. The ordering system may have a mapping module (which may be part of the set-up module 5) that determines the relative position and arrangement of the serving locations within the general service zone and transmits that determination to the mobile device, optionally via the management system 1a. In one form, the mapping module may provide for the manually entry data by staff of the general service zone concerning the relative arrangement of the serving locations 8a, 8b, 8c. More specially, the mapping module may comprise a device 5a configured with a graphical user interface arranged to receive a user (staff) input to designate the relative position of serving locations 8a, 8b, 8c within the general service zone 8.

By way of illustration, and referring to FIG. 5, an implementation of this function of the mapping module is shown that achieves a table layout set up using a staff tablet device 5a. An operator holds the tablet, drags and drops tables onto layout (e.g. from 2 to 1, 3 to 1), then presses complete (4) to finalise the layout.

This can be utilised in conjunction with wireless technology, wherein the mapping module determines the relative position and arrangement of the serving locations by communicating with identification articles, each situated at a respective serving location.

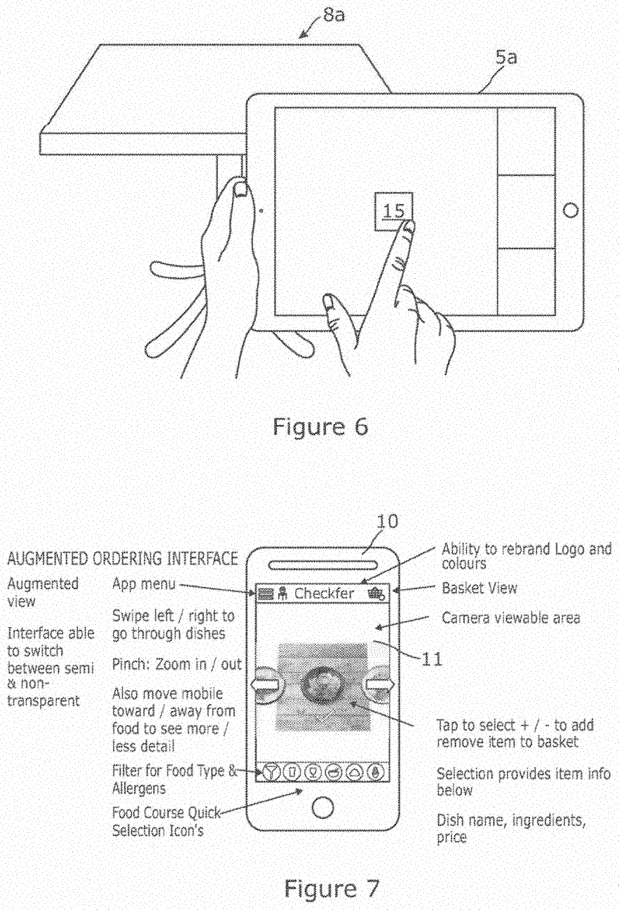

For example, referring to FIG. 6, an operator can hold a tablet close to a table (preferably directly on/above table service), and then select the previously provided table layout to register a beacon 9a, 9b, 9c with a particular location 8a, 8b, 8c. A table number or identifier, for example, can therefore be transmitted between the tablet 5a and the beacon for registration.

In alternatives, the system may be able to “auto-configure” the location of tables. For example, identification articles such as beacons 9a, 9b, 9c may be arranged to issue wireless localisation signals, the reception of which enables the determination of the position of each identification article relative to at least one other.

Where the identification articles comprise beacons 9a, 9b, 9c, each is arranged to wirelessly transmit a unique serving location identifier, and the mobile device is configured by the application to receive the serving location identifier transmitted by the beacon of the chosen serving location.

To avoid the possibility of “checking in” to the wrong table, it is desirable for certain implementations to ensure that the wireless transmission is restricted. Moreover, each beacon 9a, 9b, 9c is arranged to wireless transmit its own unique serving location identifier in a manner that substantially restricts its reception to a mobile device 10 situated at the corresponding serving location 8a, 8b, 8c.

Additionally, beacons 9a, 9b, 9c comprise a broadcasting configuration in which its unique serving location identifier is wirelessly broadcasted, and a passive configuration in which the beacon restricts wireless broadcasts so as to conserve power. However, so that broadcasting occurs when needed, an activation input, such as a vibration, may be used to activate the broadcasting configuration. A vibration may be provided as a result of a customer sitting down at a table.

Naturally, a restaurant or other service zone 8 may have opening times outside of which no ordering activity takes place. Accordingly, it can be beneficial to conserve power of beacons outside normal opening hours, and so each beacon may be scheduled to switch between the broadcasting configuration and the passive configuration at certain time custom-chosen by the owner of a general service zone 8.

Referring back to FIG. 5, the mapping module can therefore be used to generate and display, on an electronic device 5a (such as the one that is part of the set-up module 5) a map of the general service zone 8. Once this has been set up, it can also be displayed on a customer mobile device 10. Thus the mapping module can transmit, optionally via the management system 1a a map to the mobile device 10 associated with an ordering user.

Visual artefacts on the map being displayed can represent a serving location such as a table. These can be positioned and arranged relative to one another on the map in correspondence with the relative position and arrangement of the serving locations, and furthermore may have representations that are unique to a serving location (such as a table number), the reservation status of a serving location (such as whether a table is available, or reserved), and furthermore an appearance which is dependent on the use of that serving location. For example, tables depicted on the map may be coloured in dependence on how long ago an order was sent from the corresponding table. (e.g. green for a recent order and red for an overdue/unfulfilled order). The visual artefacts may be supplemented with guidance instructions to guide the user to an available serving location.

An advantage of the present system is the ability for customers to quick place and pay for an order via the application 20. To this end, each menu item has an associated cost, and the executed application 20 configures the mobile device 10 to calculate a total cost of the order from the aggregated cost of each menu item selected by the user. This total cost is presented to a customer via the touch-sensitive screen 11 of the mobile device 10, and following user/customer confirmation, the executed application 20 configures the mobile device 10 to issue, via the wireless telecommunication module 12, a payment request to a remote payment system 7, the payment request including the total calculated cost of the order, the mobile device 10 being further configured to receive a payment receipt from the payment system 7 to certify successful payment for the order. Additionally, the service instruction system 4 is configured to receive a payment confirmation from the remote payment system 7, the payment confirmation certifying successful payment for the order.

This provides a restaurant 8, or another service provider, with certainty that they can go ahead and fulfil the order.

It will be appreciated that each restaurant may have its own unique menu. Accordingly, it is useful to be able to provide this to the application 20 when appropriate—namely, when a user/customer is close to the restaurant, and so likely to be soon entering the restaurant 8 to place an order. Accordingly, the application 20 configures the mobile device 10 of that customer to determine the location of the mobile device 10 relative to the restaurant (or another general service zone 8) and execute a proximity routine on determining that the mobile device is within a predetermined proximity to the general service zone. In the present embodiment, this proximity routine comprises displaying a proximity prompt to indicate to a user the proximity of the mobile device 10 to the general service zone and downloading, via the wireless telecommunication module 12, the menu associated with the proximal general service zone.

To further enhance the user experience, an augmented reality mode may be supported by the system 1 as a whole, for example for the purpose displaying menu items, guidance instructions or other information.

Specifically, the sensor set of the mobile device comprises a camera 17b, and the executed application configures the mobile device 10 to present, via the screen 11, an augmented reality view of the general service zone 8, with virtual representations. These can be presented simultaneously with an image of at least a part of the general service zone 8 as captured by the camera 17b of the mobile device 10.

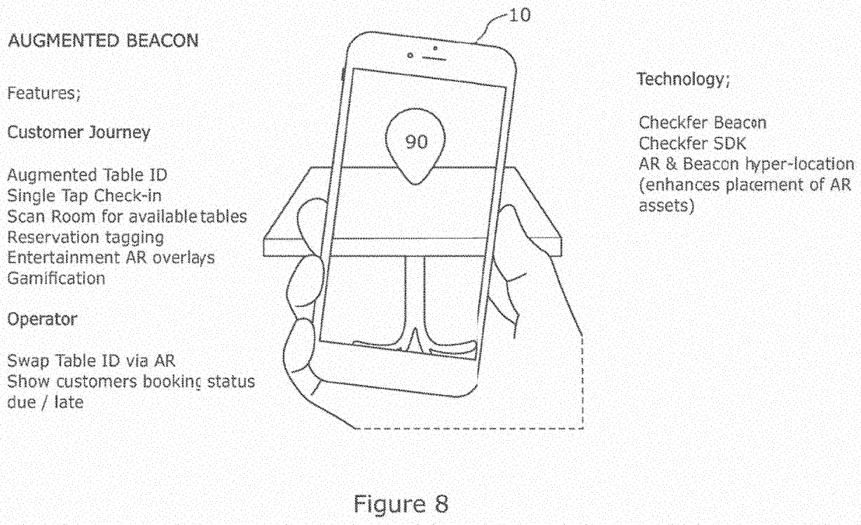

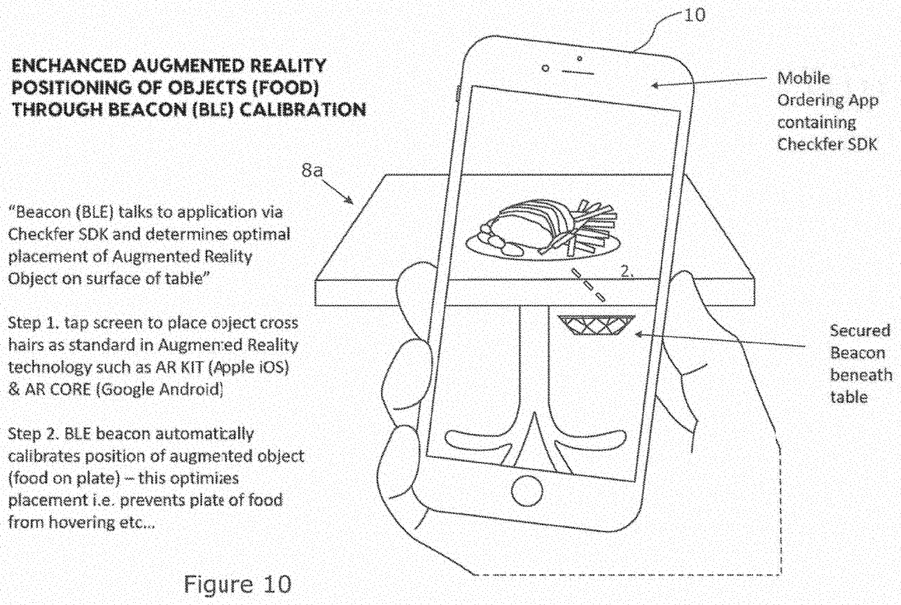

For example, referring to FIGS. 7 and 10, images of menu items can be displayed superimposed over a captured image of table, and referring to FIG. 8, guidance instructions or other information (such as a table number) can also be virtually represented at a correct position on the screen relative to the captured image of the table.

The correct position, size and orientation of those images are controlled in dependence on the detected position of the table. To this end, the executed application 20 is arranged to determine, via the sensor set, the position and orientation of the mobile device 10 relative to that of the general service zone 8, and the physical items within in, and in response modify the size, shape and/or orientation of the virtual (augmented reality) representations of the menu items and/or guidance instructions to give the appearance of the virtual (augmented reality) representations being at fixed locations within general service zone 8.

Moreover, the camera 17b of the mobile device 10 can be configured by the application 20 to capture a live image feed that is continuously displayed on the screen 1 of the mobile device 10. The modification of the virtual (augmented reality) representations are continually updated in response to movement of the mobile device 10 relative to the general service zone 8. Thus, as a user or customer scans the restaurant with their mobile device, different table numbers may be virtually represented on the screen in place at the appropriate table, as viewed via the screen 11.

Accordingly, as the size, shape and/or orientation of the virtual representations of the menu items are continually modified, this gives the appearance of those virtual representations being presented in place at the chosen serving location 8a, 8b, 8c.

Referring to FIG. 10, the accuracy with which the mobile device can detect its position within the general service zone, and moreover relative to a serving location such as a table can be improved through the use of a beacon 9a, 9b, 9c. The beacon can be affixed to a predetermined location on a serving location such as a table, and so the beacon can act as a reference for the location of the upper surface of the table. This can be achieved via radio localisation communications between the beacon and the mobile device 10, and these can furthermore be used in conjunction with other localisation techniques such as the image detection of an upper planar surface of the table.

So that a relatively accurate representation of menu items can be displayed, it is necessary to pre-generate those representations. Naturally, as menu items are typically unique to a restaurant, it is useful to “scan” meals that have been prepared by a restaurant in a reliable manner, ideally to generate a 3D colour model. One way to achieve this is to use a 3D scanning application loaded on to a mobile device which captures image and depth information. However, the hand-held operation of such mobile devices often leads to poorly-scanned objects.

One reason for this is that it is difficult to reliably 3D scan an object (such as a meal) in isolation without unintentionally capturing other image artefacts, and in a way that captures all of the relevant image/depth data.

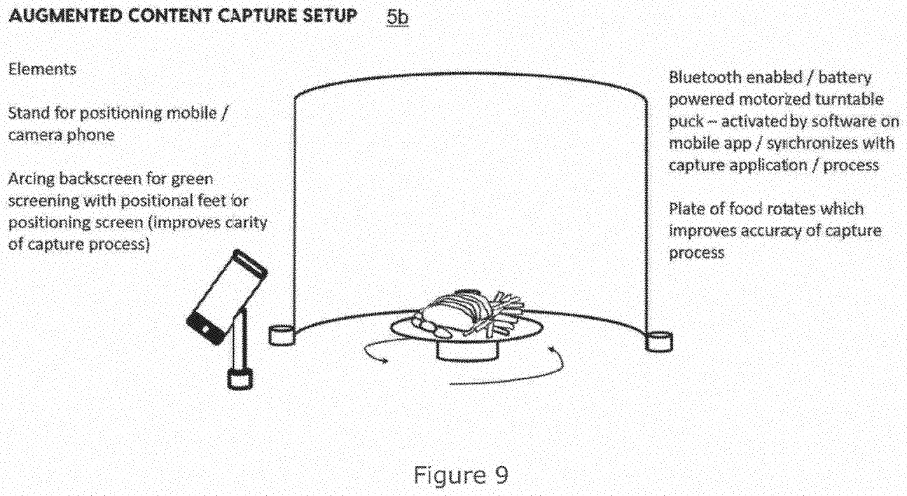

Referring to FIG. 9, a 3D content capture system 5b, which is part of the set-up module 5, for overcoming these issues is shown. This content capture system 5b comprises a holder for holding the scanning mobile device in a predetermined orientation, a turntable, and a backscreen for presenting a predetermined backdrop (which is later digitally removed). The turntable rotates at a predetermined speed, or otherwise the rotational position of the turntable is registered with the scanning mobile device such that an accurate 3D model of the object on the turntable can be captured. The backscreen is commonly referred to as a “green-screen”—but may be of a different colour to improve digital removal of the backdrop to generate the 3D model in isolation.

As generally discussed above, the service instruction system 4 of the order management system 1 is arranged to receive orders and issue serving instructions to service staff to fulfil those orders at one of many serving locations 8a, 8b, 8c. An additional enhancement to the service instruction system 1 is provided by tracking the location and behaviour of service staff fulfilling those order. This can be used, for example, to monitor service staff performance. This also provides a convenient way for information to be passed to and from ordering users about the service provided by service staff groups or individuals, and so can be used to tip service staff for good service.

To this end, the order management system 1 comprises service staff tracking devices 6a for use with the staff tracking system 6. In a preferred embodiment, these are each in the form of a staff identification badge 6a. These staff tracking devices 6a ideally comprise a transceiver which signal the presence and/or location of the device 6a relative to other devices of the ordering management system 1—for example, with one or more table beacons 9a, 9b, 9c, location beacons 9d (optionally also acting as “mesh” beacons), and/or one or more mobile devices 10 of ordering users. Accordingly, these staff-tracking devices 6a may be referenced as a “beacon badge” 6a. Ideally, the transceiver is a low-energy Bluetooth transceiver (BLE), but it will be appreciated by those skilled in the art that many other viable alternatives exist.

As is typical with traditional badges, the staff identification badges 6a of the present embodiment visually bear the identity of the service staff wearing the badge (e.g. a printed name)—which aids ordering users to correctly identify and tip the correct staff member. Advantageously, as the badge 6a is an article normally worn by serving staff, this eliminates the disadvantages of staff needing to carry a separate device. Furthermore, as badges are normally worn by staff, this improves the chance that staff remember to wear them.

Each badge 6a comprises a staff unique identifier which is registered with other components of the ordering management system during the set up and normal operation of the ordering management system.

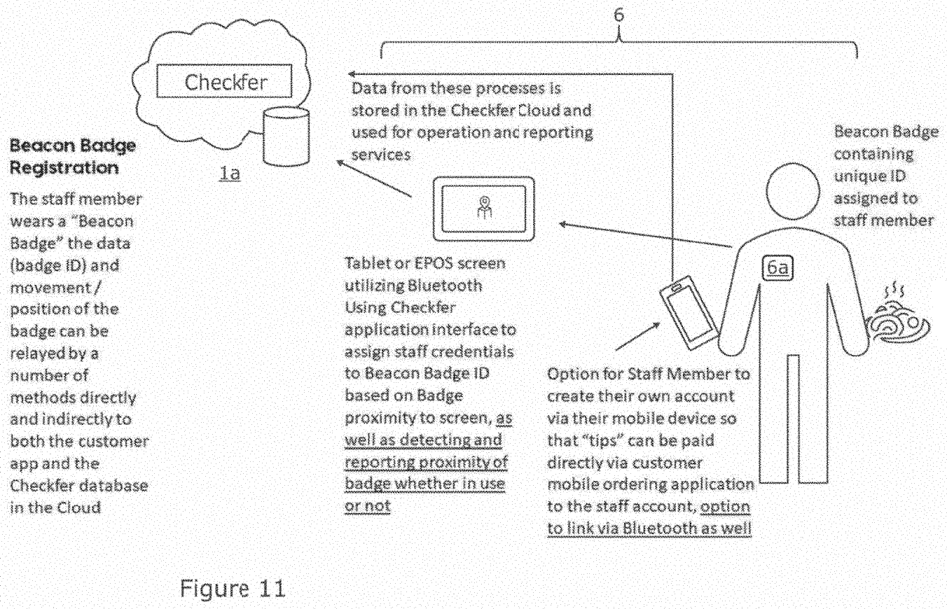

A registration process may be as follows, with reference to FIG. 11:

Staff members and/or management staff may assign the beacon badge 6a to applications associated with the management system 1a, such as the Checkfer Web Enabled Interface either via a tablet 5a provided or a PC screen. These users are able to link the Badge ID data with their own (or the relevant staff) identity (name etc. . . . ) so that this information can be reported and/or integrated with 3rd party systems such as Time & Attendance/Payroll functions, which may also be managed via the management system 1a.

A staff member may setup their own profile via a Checkfer set-up application (optionally part of the set-up module 5) so they can pair their beacon badge details with their account so that tips from customers can be processed directly to their own individual payment scheme (e.g. Paypal).

The proximity of the badges 6a of the Checkfer Tablet 5a (as well as Bluetooth enabled EPOS) provided enables Badges data to be passed so that it can be reported on.

In addition there is an option for the application provided either via the Tablet/or EPOS system for the staff member to be assigned to tables or a group of tables (zone).

Beacon Badge: Operational Processes, with reference to FIG. 12:

Beacon Badge ID & Movement (source) Data can be passed and realized within the various (destination) applications namely—Customer Mobile (as above restaurant tablet and epos systems), Table Beacons and additional Mesh Beacons (which can track a user's movements around the restaurant).

#1 Is where the Badge Beacon ID data is directly transmitted to the customer ordering application 20 (#A) (owing to the customer mobile 10 wireless communication module 12—especially, a Bluetooth part of this module—being turned on) and if elected the combination of tables/zone assigned to the staff members beacon badge ID;

#2 Is where the Badge Beacon ID data relays via the table beacon 9a to the customer ordering application 20 on their device 10 (#B & #C);

#3 Is where the Badge Beacon ID data relays via an additional mesh beacon (network*) (#D & #E) to the customer ordering application 20 on their device 10;

*a network of 2 or more beacons distributed throughout a space, the beacons interoperate with themselves and other Bluetooth devices in order to transmit data (in this case the location of Bluetooth devices and movement—using a method called triangulation, this data is then stored and can be retrieved for reporting later or real-time for operation use).

Interoperating location beacons 9d and table beacons 9a, 9b, 9c can form such a mesh beacon network.

#4 Is where the Badge Beacon ID data relays via an additional mesh beacon via the Checkfer Cloud services 1a back to the ordering application 20 on the customers mobile 10 (#D, #F & #G);

Assignment of Staff Member Beacon Badge ID to Customer Orders (Technical Methodologies).

The dwell (time and proximity, adjacent to the customer mobile device 10) of the staff members Beacon Badge ID will poll the customer order application in the background and be logged within the application 20—when the customer is presented on the application 10 with the option to “tip” the staff member, this staff ID data will be presented to ensure that the correct staff member has been tipped (the assignment to tables above ensures “mis-tipping does not occur”.

Or the Beacon Badge ID data is pushed over the Checkfer Cloud 1a down to the customer mobile application 20—using the previously linked Beacon Badge ID to Table Beacon/Grouping (Zones) to assign the Beacon Badge ID to the customer's order.

There is also an option for an additional customer interaction whereby the first polling of the staff member beacon ID data appears on the customer ordering app 20 on the customers devices 10—the staff member can announce that they will be serving the customer today—and that the customer just need select the staff members ID/Image on the application 20—thereby bonding the customers' orders to the staff member (either option of assigning will work)—a combination of these methods can also be used to ensure that the staff is assigned to the customer order, just in case the customer mobile malfunctions and/or the customer has turned their Bluetooth off.

In general, it is possible to correlate a staff tracking device 6a with other components of the system 1 in many different ways or a combination of ways such as:
assigning the staff tracking device identifier to one or more serving locations 8a, 8b, 8c by specifying the assignment via a set-up module or device 5 (e.g. via a management tablet interface 5a);
via proximity of the tracking device 6a to a mobile device 10 executing the mobile application 20. This can be used to register that a service staff member has been physically close to an ordering user/or their table 8a, and depending on other parameters (such as “dwell time”) can therefore be used to infer an outcome (such as successful fulfilment of an order, or registration);
the staff tracking device connects with a table beacon 9a whereby data transmission occurs via the table beacon 9a to the mobile device 10 running the application 20; and/or
the inclusion of a mesh beacon network whereby beacons 9a-9d pick up the movement of the staff badge beacon id and relay the data to the other components of the system 1, such as the mobile device(s) 10 of ordering users.

Furthermore, arrangement and use of such components of the ordering management system 1 allow staff movement data to be gathered continuously. This information can be transmitted to a staff management interface, and/or to the Checkfer data gateway (e.g. as part of management system 1a). This allows the tracking and identification of many statistics and performance metrics, an important one of which is how responsively an order is fulfilled.

Accordingly, it is possible to identify the service staff members for many purposes, one of which is allowing users to reward those members with tips for good service. Accordingly, the mobile application 20 may provide an option to transmit an additional “tip” payment upon fulfilment of the order.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

1. An order management system comprising:
a general service zone, in the form of a restaurant, comprising a plurality of serving locations, in the form of tables;
a service instruction system for issuing serving instructions to service staff of the general service zone; and
a mobile device associated with an ordering user, the mobile device comprising a touch-sensitive screen, a sensor set and a wireless
telecommunication module, the wireless telecommunication module being arranged to download an application for execution on the mobile device, and the executed application configuring the mobile device to:
present to the ordering user, via the touch-sensitive screen, a menu associated with the general service zone;
receive from the ordering user, input selections to select items on the menu to generate an order therefrom, the order comprising at least one selected menu item and a unique order identifier;
determine, using the sensor set, a serving location identifier that uniquely identifies one of the plurality of serving locations within the general service zone chosen by the ordering user; and
transmit, via the wireless telecommunication module, the order and the determined serving location identifier to the service instruction system, the order and the determined serving location identifier being associated with one another; wherein:
the service instruction system is configured to receive the order and the associated serving location identifier and, in response, issue a serving instruction to service staff to fulfil the order at said serving location chosen by the ordering user.

2. The order management system of claim 1, further comprising a plurality of identification articles each situated at a respective serving location, and wherein the executed application configures the mobile device to determine the serving location identifier from the identification article situated at the serving location chosen by the ordering user, wherein each identification article comprises a respective and unique serving location image that is displayed at its corresponding serving location, and the sensor set of the mobile device comprises an image detector, the mobile device being configured by the executed application to use the image detector to scan the serving location image of the chosen serving location, and then determine the corresponding serving location identifier from the scanned serving location image.

3. (canceled)

4. (canceled)

5. The order management system of claim 1, wherein each identification article comprises a beacon, each being arranged to wirelessly transmit a unique serving location identifier, and the mobile device is configured by the application to receive the serving location identifier transmitted by the beacon of the chosen serving location, wherein each beacon comprises a broadcasting configuration in which its unique serving location identifier is wirelessly broadcasted, and a passive configuration in which the beacon restricts wireless broadcasts so as to conserve power.

6. (canceled)

7. (canceled)

8. (canceled)

9. (canceled)

10. The order management system of claim 1, wherein at least one of the service instruction system and the mobile device is arranged to display a map of the general service zone, the map comprising a plurality of visual artefacts each uniquely representing a corresponding serving location, wherein the visual artefacts are positioned and arranged relative to one another on the map in correspondence with the relative position and arrangement of the serving locations, wherein the service instruction system is configured to receive the order and the associated serving location identifier and, in response, modify the appearance of the visual artefact associated with the serving location identifier in dependence on time elapsed from time of receipt of the order, wherein the appearance of the visual artefact is modified by colour, with a first colour indicating a first range of time elapsed, and a second colour indicating a second range of time elapsed.

11. (canceled)

12. (canceled)

13. (canceled)

14. The order management system of claim 1 further comprising a mapping module for determining the relative position and arrangement of the serving locations within the general service zone and transmitting that determination to at least one of the service instruction system and the mobile device, wherein the mapping module determines the relative position and arrangement of the serving locations by communicating with identification articles, each situated at a respective serving location, wherein the identification articles are arranged to issue wireless localisation signals, the reception of which enables the determination of the position of each identification article relative to at least one other, wherein the mapping module comprises a graphical user interface arranged to receive a user input to designate the relative position of serving locations within the general service zone.

15. (canceled)

16. (canceled)

17. (canceled)

18. The order management system of claim 1, wherein the instruction system comprises at least one of:
a screen on which the serving instruction is displayed; and
a printer via which the serving instruction is printed.

19. The order management system of claim 1, wherein each menu item has an associated cost, and the executed application configures the mobile device to calculate a total cost of the order from the aggregated cost of each menu item selected by the user, wherein the executed application configures the mobile device to present, via the touch-sensitive screen, the total cost of the order to the user, wherein the executed application configures the mobile device to issue, via the wireless telecommunication module, a payment request to a remote payment system, the payment request including the total calculated cost of the order, the mobile device being further configured to receive a payment receipt from the payment system to certify successful payment for the order, wherein the service instruction system is configured to receive a payment confirmation from the remote payment system, the payment confirmation certifying successful payment for the order, wherein the service instruction system is configured to receive the payment confirmation and, in response, include within the serving instruction information confirming successful payment for the order.

20. (canceled)

21. (canceled)

22. (canceled)

23. (canceled)

24. The ordering management system of claim 1, wherein the executed application configures the mobile device to:
determine the location of the mobile device relative to the general service zone; and
execute a proximity routine on determining that the mobile device is within a predetermined proximity to the general service zone.

25. The ordering management system of claim 24, wherein the proximity routine comprises displaying, via the touch-sensitive screen, a proximity prompt to indicate to a user the proximity of the mobile device to the general service zone.

26. The ordering management system of claim 24, wherein the proximity routine comprises downloading, via the wireless telecommunication module, the menu associated with the proximal general service zone.

27. The ordering management system of claim 1, configured to determine reservation information associated with at least one serving location within the general service zone, the executed application configuring the mobile device to receive and display, via the touch-sensitive screen, the reservation information to a user thereby identifying to a user the availability of the at least one serving location, wherein the executed application configures the mobile device to display, via the touch-sensitive screen, guidance instructions to guide the user to the at least one serving location, wherein the guidance instructions comprise a map of the general service zone, the map comprising a plurality of visual artefacts each uniquely representing a corresponding serving location, wherein the visual artefacts are positioned and arranged relative to one another on the map in correspondence with the relative position and arrangement of the serving locations.

28. (canceled)

29. (canceled)

30. (canceled)

31. The order management system of claim 1, wherein the executed application configures the mobile device to, in response to determining the serving location identifier:
display, via the touch-sensitive screen, an identification of the serving location associated with the determined serving location identifier; and
receive a check-in interaction from the user to confirm acceptance by the user of the identified serving location and in response transmit, via the wireless telecommunication module, the determined serving location identifier to the service instruction system.

32. The order management system of claim 1, wherein the sensor set of the mobile device comprises a camera, and the executed application configures the mobile device to present, via the screen, an augmented reality view of the general service zone, with virtual (augmented reality) representations of at least one of:
menu items; and
guidance instructions that include the location of one or more available serving locations;
being presented simultaneously with an image of at least a part of the general service zone as captured by the camera of the mobile device, wherein the executed application is arranged to determine, via the sensor set, the position and orientation of the mobile device relative to that of the general service zone and in response modify the size, shape and/or orientation of the virtual (augmented reality) representations of the menu items and/or guidance instructions to give the appearance of the virtual (augmented reality) representations being at fixed locations within general service zone, wherein the executed application configures the camera of the mobile device to capture a live image feed that is continuously displayed, in use, on the screen of the mobile device, the modification of the virtual (augmented reality) representations being continually updated in response to movement of the mobile device relative to the general service zone, wherein the executed application configures the mobile device to modify the size, shape and/or orientation of the virtual (augmented reality) representations of the menu items to give the appearance of those virtual (augmented reality) representations being presented in place at the chosen serving location.

33. (canceled)

34. (canceled)

35. (canceled)

36. (canceled)

37. (canceled)

38. (canceled)

39. The order management system of claim 1, further comprising a service staff tracking system for tracking the position of service staff members relative to the plurality of serving locations, wherein the service staff tracking system is configured to determine a fulfilment visit by at least one service staff member to the serving location chosen by the ordering user, the fulfilment visit fulfilling at least part of the order, wherein the service staff tracking system is further configured to transmit an identification of said at least one service staff member to the mobile device associated with the ordering user, the mobile device, in response, being configured to:
present to the ordering user, via the touch-sensitive screen, an identification representation of the at least one service staff member;
receive from the ordering user, via the touch-sensitive screen, a tip payment input that specifies a tip value and an identification of the service staff member chosen by the ordering user as a recipient of that tip value; and
transmit, via the wireless telecommunication module, a tip payment request to a remote tip payment system, the tip payment request including the tip value and the identification of the service staff member specified by the ordering user, wherein the identification representation comprises at least one of: a name of the service staff member and an image, such as a photograph, of the service staff member, wherein each portable service staff tracking device comprises an identity badge worn by a respective service staff member, the identity badge supporting indicia visible to ordering users and conveying information about the identity of the service staff member, wherein each staff tracking device is arranged to transmit a localisation signal for use in determining the position of a respective tracking device relative to the plurality of serving locations.

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. An order management method comprising:
presenting to an ordering user, via a screen of an electronic device, a menu associated with a general service zone;
receiving input selections from the ordering user to select items on the menu to generate an order therefrom, the order comprising at least one selected menu item and a unique order identifier;
determining serving locations within the general service zone for the ordering user;
determining a serving location identifier that uniquely identifies the chosen serving location;
associating the order and the determined serving location identifier with one another;
transmitting the order and the determined serving location identifier to a service instruction system of the general service zone; and
issuing a service instruction, via the service instruction system to service staff to fulfil the order at said serving location.

54. An order management method comprising:
determining an ordering location at which a menu order is to be fulfilled;
selecting a restaurant that is proximal to the ordering location;
presenting to an ordering user, via a screen of said mobile electronic device, a menu associated with said restaurant;
receiving input selections from the ordering user to select items on the menu to generate an order therefrom, the order comprising at least one selected menu item and a unique order identifier;
determining a serving location within the restaurant;
transmitting the order to a service instruction system of the restaurant; and
issuing a service instruction, via the service instruction system, to service staff to fulfil the order at said serving location.

55. The order management method of claim 54, further comprising:
detecting, using a sensor set of the mobile electronic device, a location of the mobile electronic device; and
designating the detected location of the mobile electronic device as the ordering location.

56. The order management method of claim 55, further comprising:
determining a set of restaurants that are proximal to the ordering location; and
presenting to the ordering user, via the screen of the mobile electronic device, the determined set of restaurants;
wherein selecting a restaurant that is proximal to the ordering location comprises receiving a selection by the ordering user of one of the presented set of restaurants.

57. The order management method of claim 56, wherein selecting a restaurant that is proximal to the ordering location triggers downloading, via a wireless telecommunication module of the mobile electronic device, the menu associated with said restaurant.

58. The order management method of claim 54, further comprising:
detecting, using a sensor set of the mobile electronic device, a location of the mobile electronic device;
determining that the mobile electronic device is within a predetermined proximity to a restaurant; and
displaying, via the screen of the mobile electronic device, at least one of: a brand, colour scheme and menu of that restaurant.
